(19) United States
(12) Patent Application Publication
(10) Pub. No.: US 2017/0240771 A1
(43) Pub. Date: Aug. 24, 2017

(54) IMPROVED CURE MASKING AREA FOR UV CURABLE ADHESIVES IN DISPLAY APPLICATIONS

(71) Applicant: 3M INNOVATIVE PROPERTIES COMPANY, St. Paul, MN (US)

(72) Inventors: Christopher J. Campbell, Burnsville, MN (US); Brian D. Pennington, North Oaks, MN (US); Han-Chi Tsai, Taoyuan County (TW); Tzong-Yiing Chiang, Taoyuan County (TW)

(21) Appl. No.: 15/506,115

(22) PCT Filed: Sep. 1, 2015
(86) PCT No.: PCT/US2015/047851

§ 371 Date: Feb. 23, 2017

Related U.S. Application Data
(60) Provisional application No. 62/044,551, filed on Sep. 2, 2014.

(51) Int. Cl. C09J 5/00; C09J 11/06; B05D 3/06; C09J 4/00

(52) U.S. Cl. CPC C09J 5/00; C09J 4/00; C09J 11/06; B05D 3/067; C09J 2205/31; C08K 5/37

(57) ABSTRACT

The present invention is a method of curing an adhesive composition positioned at least partially under a light-absorbing layer. The method includes providing an adhesive composition, positioning the light-absorbing layer over a surface of the adhesive composition such that there is an exposed area of the adhesive composition and a covered area of the adhesive composition and irradiating the exposed area of the adhesive composition and the covered area of the adhesive composition at the surface at a dosage of between about 100 mJ/cm² and about 10,000 mJ/cm². The adhesive composition includes a solute (meth)acryolyl oligomer having a molecular weight of 4 to 30 k and a Tg of less than about 20° C., a diluents monomer component and a photoinitiator.

### FIELD OF THE INVENTION

The present invention is related to the field of adhesives. In particular, the present invention is related to UV curable adhesives.

### BACKGROUND

Liquid optically clear adhesives (LOCAs) have become prevalent in the display industry to fill the air gaps between substrates. For example, LOCAs are often used to fill in the gap between a cover lens and touch sensors, touch sensors and a liquid crystal module, or directly between a cover lens and a liquid crystal module. Most LOCAs are UV curable acrylates and/or silicone resins. The display configurations are typically built from the front/top of the display backwards, such that the cover lens (with a light absorbing ink step) is bonded to a touch sensor to form a stack, and subsequently bonding the stack to the LCD module and/or AMOLED stack. For optical reliability and display performance, it is critical to cure all of the LOCAs, even those coated outside the viewing area and under the ink step, to prevent display defects such as yellow mura and light leakage, or cosmetic defects such as oozing. While a UV transparent ink could be used (e.g. WO2012071144), this is not a common practice in the industry. Quite often the light absorbing ink step does not transmit UV light, leading to either insufficient or no cure under the ink step.

To cure under the light absorbing ink step, it is possible to pre-cure the LOCA prior to lamination (e.g. U.S. Pat. No. 8,628,637 or WO2013/111810). However, this can lead to a loss in adhesion performance and display defects (e.g. yellow mura and light leakage) caused by either coating defects (e.g. picture framing) and/or poor lamination. Alternatively, a secondary cure using, for example, a thermal initiator (e.g. U.S. Pat. No. 8,087,967 or US2011021655) could be used to cure the area under the light absorbing ink step. However, this requires additional equipment (i.e., a heat oven) and exposes the display stack to temperatures of greater than 60° C. to achieve cure. Most display manufacturers do not want to expose their liquid crystal modules (LCMs) to temperatures of greater than 40° C. Finally, irradiation from the side (e.g. U.S. Pat. No. 7,927,533) under the ink step can be used to attempt to cure the LOCA. However, this method requires painstaking alignment aiming for a 150 μm thick LOCA layer and may not be able to achieve the necessary depth of cure and/or cure through flex circuitry or other items obscuring cure from the side.

### SUMMARY

In one embodiment, the present invention is a method of curing an adhesive composition positioned at least partially under a light-absorbing layer. The method includes providing an adhesive composition, positioning the light-absorbing layer over a surface of the adhesive composition such that there is an exposed area of the adhesive composition and a covered area of the adhesive composition and irradiating the exposed area of the adhesive composition and the covered area of the adhesive composition at the surface at a dosage of between about 100 mJ/cm² and about 10,000 mJ/cm². The adhesive composition includes a solute (meth)acryolyl oligomer having a molecular weight of 4 to 30 k and a T_{g} of less than about 20 ° C., a diluents monomer component and a photoinitiator.

In another embodiment, the present invention is method of curing an adhesive composition positioned at least partially under a light-absorbing layer. The method includes providing an adhesive composition, positioning the light-absorbing layer over a surface of the adhesive composition such that there is an exposed area of the adhesive composition and a covered area of the adhesive composition, and irradiating the surface of the adhesive composition such that the adhesive composition is at least about 80% cured.

### BRIEF DESCRIPTION OF THE DRAWINGS

FIG. 1A is a cross-sectional view of a first embodiment of a display configuration.

FIG. 1B is a cross-sectional view of a second embodiment of a display configuration.

FIG. 2 is a front view of an ink cover glass tool used in the Examples.

FIG. 3 is a schematic view the display configuration used in the Examples.

FIG. 4 is a schematic of the representative areas for measuring cure using the method of the present invention.

FIG. 5a is a graph of the modulus as a function of dose during the curing step at a dosage of 100 mJ/cm².

FIG. 5b is a graph of the modulus as a function of dose during the curing step at a dosage of 200 mJ/cm².

FIG. 5c is a graph of the modulus as a function of dose during the curing step at a dosage of 400 mJ/cm².

FIG. 5d is a graph of the modulus as a function of dose during the curing step at a dosage of 800 mJ/cm².

FIG. 6 is a graph of the modulus after the doses of FIG. 5a-d are applied.

These figures are not drawn to scale and are intended merely for illustrative purposes.

### DETAILED DESCRIPTION

The present invention is method of curing an adhesive composition through a light absorbing layer, such as an ink step, using UV radiation. Using the method of the present invention, curing the adhesive composition by UV radiation may take place at a cure depth of greater than about 5 millimeters. The ability to cure the adhesive composition through an ink step rather than pre-curing prior to lamination, performing a secondary cure or irradiating from the side of the display increases adhesion performance, decreases display defects and eliminates cost.

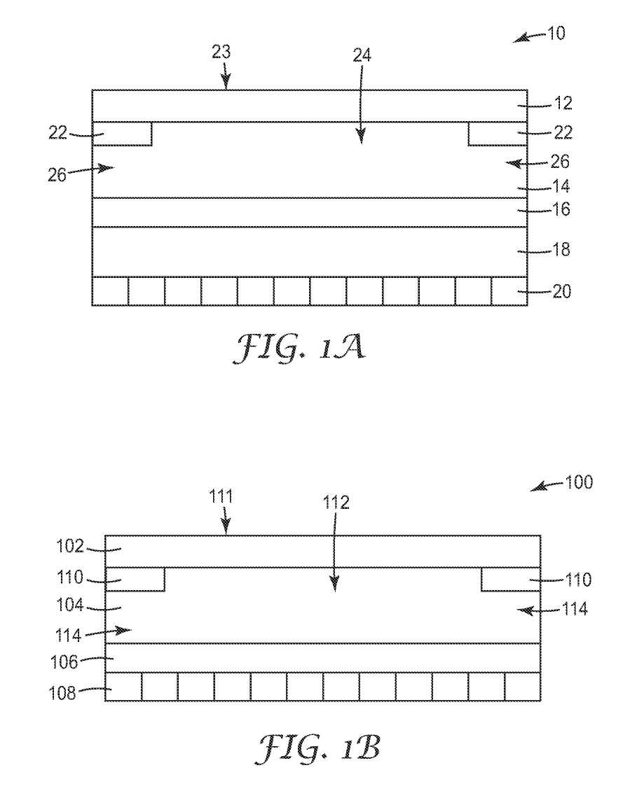

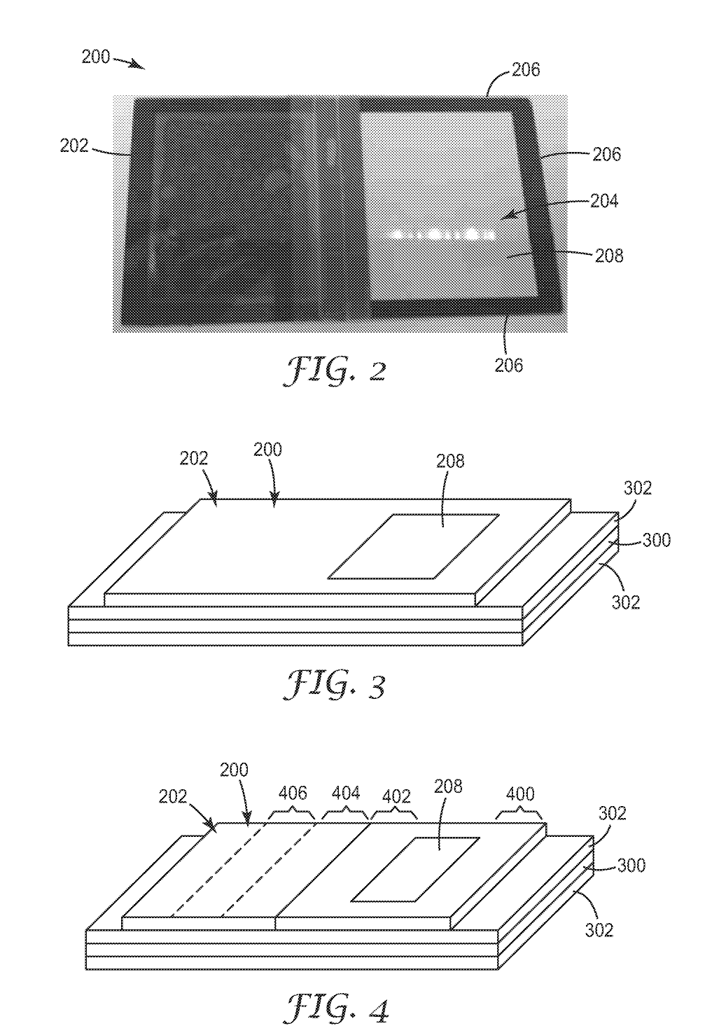

As mentioned above, liquid optically clear adhesives (LOCAs) are often used to fill in gaps in display applications. FIG. 1A shows a cross-sectional view of a first embodiment of a display configuration 10 in which the method of curing an adhesive composition through a light absorbing layer of the present invention can be used. The display configuration 10 of FIG. 1A includes a cover glass (such as a cover lens) 12, a first adhesive layer 14, a touch sensor 16, a second adhesive layer 18, a liquid crystal display module 20 and a light absorbing ink step 22. The method of the present invention can be used to cure the entire height and length of the first and second adhesive layers 14 and 18 of the display configuration by irradiating through a top surface 23 of the display configuration 10.

FIG. 1B shows a cross-sectional view of a second embodiment of a display configuration 100 in which the method of curing an adhesive composition of the present invention can be used. The display configuration 100 in FIG. 1B includes a cover glass (such as a cover lens) 102, an adhesive layer 104, a touch sensor 106, a liquid crystal display module 108 and a light absorbing ink step 110. Similar to the first display configuration 10, the adhesive layer 104 of the display configuration 100 is cured using the method of the present invention and can be cured by irradiating UV light through a top surface 111 of the display configuration 100.

In practice, as can be seen in FIGS. 1A and 1B, when the display configurations are assembled, at least a portion of the adhesive layers 14, 18 and 104 are positioned under the light-absorbing ink step 22, 110 such that there is an exposed portion of the adhesive layers 24, 112 and a covered portion of the adhesive layers 26, 114, as viewed from the top surfaces 23, 111 of the display configurations 10, 100. The adhesive layers 14, 18 and 104 used in the present invention, including the portions positioned below the light absorbing ink step, can be cured solely with irradiation of UV light from the top surfaces 23, 111 of the display configurations 10, 100, i.e., through the light absorbing ink step 22, 110 without the need for a secondary cure step. The exposed and covered portions of the adhesive layers 14, 18 and 104 are cured at a total dosage of between about 100 mJ/cm² and about 10,000 mJ/cm² and particularly between about 300 and about 6000 mJ/cm². In one embodiment, the adhesive composition is cured at a dosage of about 500 mJ/cm² per pass.

In one embodiment, the method of the present invention can be used even when the light absorbing ink step 22, 110 has a thickness of up to about 5 μm. Particularly, the light-absorbing ink 22, 110 step can have a thickness of up to about 10 μm, particularly up to about 80 μm and more particularly up to about 100 μm. The ability to cure the adhesive composition positioned underneath the light absorbing ink step 22, 110 depends on a number of factors, including the thickness of the light absorbing ink step, the thickness of the adhesive composition, and the distance between the covered portion and the exposed portion of the adhesive composition that is directly exposed to the radiation. In one embodiment, the adhesive composition can be cured using the method of the present invention up to a distance of at least about 5 millimeters (mm) away from the exposed area and up to a distance of at least about 10 mm from the exposed portion of the adhesive composition. After being exposed to the UV radiation, the adhesive composition positioned underneath the light absorbing layer is at least about 80% cured, particularly at least about 90% cured, more particularly at least about 95% cured and most particularly at least about 99% cured.

The adhesive composition used in the method of the present invention includes a solute (meth)acryolyl oligomer having a M_{w} of about 4 to about 30 k, particularly about 8 to about 15 k, and a T_{g} of <20° C., particularly <10° C., more particularly <0° C.; a solvent diluents monomer component and a photoinitiator. In one embodiment, the adhesive composition includes greater than about 50 parts by weight, particularly greater than about 80 parts and more particularly greater than about 90 parts of an oligomer having a plurality of pendent free-radically polymerizable functional groups and having a M_{w} of about 4 to about 30K and a T_{g} of <20° C. In one embodiment, the composition includes less than about 50 parts by weight, particularly less than about 20 parts, and more particularly less than about 10 parts of a diluent monomer component. In one embodiment, the composition includes about 0.001 to about 5 parts by weight, particularly about 0.001 to about 1, and more particularly about 0.01 to about 0.1 parts of a photoinitiator, based on 100 parts by weight of the oligomer and diluent solvent monomer.

The oligomer generally comprises polymerized monomer units of
a) greater than about 50 parts by weight, particularly greater than about 75 parts by weight, more particularly greater than about 80 parts by weight of (meth)acrylate ester monomer units;
b) about 10 to about 49 parts by weight, particularly about 10 to about 35 parts by weight, more particularly about 15 to about 25 parts by weight, of monomer units having a pendent hydroxy functional group,
c) about 1 to about 10 parts by weight, particularly about 1 to about 5 parts by weight, more particularly about 1 to about 3 parts by weight, of monomer units having a pendent, free-radically polymerizable functional groups, and
d) 0 to about 20 parts by weight of other polar monomer units, wherein the sum of the monomer units is 100 parts by weight.

In one aspect, the oligomer includes (meth)acrylate ester monomer units. (Meth)acrylate ester can include aliphatic, cycloaliphatic, or aromatic alkyl groups. Useful alkyl acrylates (i.e., acrylic acid alkyl ester monomers) include linear or branched monofunctional acrylates or methacrylates of non-tertiary alkyl alcohols.

Useful monomers include, for example, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, isobutyl (meth)acrylate, hexyl (meth)acrylate, n-nonyl (meth)acrylate, isoamyl (meth)acrylate, n-decyl (meth)acrylate, isodecyl (meth)acrylate, lauryl(meth)acrylate, dodecyl (meth)acrylate, cyclohexyl (meth)acrylate, phenyl meth(acrylate), benzyl meth(acrylate), tridecyl (meth)acrylate, 2-propylheptyl (meth)acryralte and 2-methylbutyl (meth)acrylate, and combinations thereof. In some embodiments, the average carbon number of the alkanol portion of the (meth)acrylates is 10 to 14.

The oligomer has a T_{g} of <20° C., particularly <10° C., more particularly <0° C. As used herein the term “low T_{g} monomer” refers to a monomer, which when homopolymerized, produce a (meth)acryloyl copolymer having a T_{g} of <20° C. The incorporation of the low T_{g} monomer to the oligomer is sufficient to reduce the glass transition temperature of the resulting copolymer to <20° C.

Suitable low T_{g} monomers having one ethylenically unsaturated group and a glass transition temperature of less than 20 ° C., particularly less than 10 ° C., include, for example, n-butyl acrylate, isobutyl acrylate, hexyl acrylate, 2-ethyl-hexylacrylate, isooctylacrylate, caprolactoneacrylate, isodecylacrylate, tridecylacrylate, laurylmethacrylate, methoxy-polyethylenglycol-monomethacrylate, laurylacrylate, tetrahydrofurfuryl-acrylate, ethoxy-ethoxyethyl acrylate and ethoxylated-nonylacrylate. Especially suitable are 2-ethyl-hexylacrylate, ethoxy-ethoxyethyl acrylate, tridecylacrylate and ethoxylated nonylacrylate.

In some embodiments, the (meth)acrylic acid ester monomer component may include (meth)acrylate esters of 2-alkyl alkanols wherein the molar carbon number average of said 2-alkyl alkanols is 12 to 32. The Guerbet alkanol-derived (meth)acrylic monomers have the ability to form (co)polymers with unique and improved properties over comparable, commonly used adhesive acrylate (co)polymers. These properties include a very low T_{g}, a low solubility parameter for acrylic polymers, and a low storage modulus creating a very conformable elastomer. When Guerbet monomers are included, the (meth)acrylate ester component may include up to 100 parts by weight, particularly up to about 50 parts by weight of the (meth)acrylate ester monomer component. Such Guerbet (meth)acrylate esters are described in Applicant's U.S. Pat. No. 8,137,807 (Lewandowski et al.) and is incorporated herein by reference.

In some embodiments, the (meth)acrylate ester is derived from alkanols having an average carbon number of C₈-C₃₂, particularly C₁₀-C₁₄. This average carbon number may be calculated based on the weight percentages of each (meth)acrylate ester monomer.

The oligomer further includes a hydrophilic, hydroxyl functional monomer. The hydrophilic, hydroxyl functional monomeric compound typically has a hydroxyl equivalent weight of less than about 400. The hydroxyl equivalent molecular weight is defined as the molecular weight of the monomeric compound divided by the number of hydroxyl groups in the monomeric compound

The hydroxyl functional monomer has the general formula:

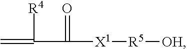

wherein
R⁵ is a hydrocarbyl group, including alkylene, arylene and combinations thereof, more particularly a C₁-C₆ alkylene;
R⁴ is —H or C₁-C₄ alkyl; and
X¹ is —NR⁴— or —O—.

Useful monomers of this type include hydroxyethyl (meth)acrylate, hydroxypropyl (meth)acrylate, 2-hydroxy-2-phenoxypropyl (meth)acrylate, and hydroxybutyl (meth)acrylate, 2-hydroxyethylacrylamide, and N-hydroxypropylacrylamide.

The hydroxyl functional monomer is generally used in amounts of 10 to 49 parts by weight based upon 100 parts total monomers of the oligomer.

The oligomer optionally further includes a hydrophilic polar monomer other than the hydroxyl-functional monomer. The hydrophilic monomer typically has an average molecular weight (Mₐ) of greater than about 70, or greater than about 500, or even higher. Suitable hydrophilic polymeric compounds include poly(ethylene oxide) segments, hydroxyl functionality, or a combination thereof. The combination of poly(ethylene oxide) and hydroxyl functionality in the polymer needs to be high enough to make the resulting polymer hydrophilic. By “hydrophilic” it is meant that the polymeric compound can incorporate at least about 25 weight percent of water without phase separation.

Typically, suitable hydrophilic polymeric compounds may contain poly(ethylene oxide) segments that include at least about 10, at least about 20, or even at least about 30 ethylene oxide units. Alternatively, suitable hydrophilic polymeric compounds include at least about 25 weight percent of oxygen in the form of ethylene glycol groups from poly(ethylene oxide) or hydroxyl functionality based upon the hydrocarbon content of the polymer.

Useful hydrophilic polymer compounds may be copolymerizable or non-copolymerizable with the adhesive composition, as long as they remain miscible with the adhesive and yield an optically clear adhesive composition. Copolymerizable, hydrophilic polymer compounds include, for example, CD552, available from Sartomer Company, Exton, Pa., which is a monofunctional methoxylated polyethylene glycol (550) methacrylate, or SR9036, also available from Sartomer, that is an ethoxylated bisphenol A dimethacrylate that has 30 polymerized ethylene oxide groups between the bisphenol A moiety and each methacrylate group. Other examples include phenoxypolyethylene glycol acrylate available from Jarchem Industries Inc., Newark, N.J.

The polar monomer component may also include weakly polar monomers such as acrylic monomer containing carboxylic acid, amide, urethane, or urea functional groups. In general, the polar monomer content in the adhesive can include less than about 5 parts by weight or even less than about 3 parts by weight of one or more polar monomers. Useful carboxylic acids include acrylic acid and methacrylic acid. Useful amides include N-vinyl caprolactam, N-vinyl pyrrolidone, (meth)acrylamide, N-methyl (meth)acrylamide, N,N-dimethyl acrylamide, N,N-dimethyl meth(acrylamide), and N-octyl (meth)acrylamide.

The hydroxyl functional monomer and polar monomers are used in amounts such that the oligomer is hydrophilic. By “hydrophilic” it is meant that the oligomeric compound can incorporate at least 25 weight percent of water without phase separation. Generally the polar monomer are used in amounts of 0 to 20 parts, based on 100 parts total monomer of the oligomer. Generally the polar monomer, when present is used in amounts of about 1 to about 10 parts, particularly about 1 to about 5 parts.

The oligomer optionally contains silane monomers [M^{Silane}] including those with the following formula:

A-R⁸—Si—(Y)ₚ(R⁹)₃₋ₚ

wherein:

A is an ethylenically unsaturated polymerizable group, including vinyl, allyl, vinyloxy, allyloxy, and (meth)acryloyl, particularly (meth)acrylate; R⁸ is a covalent bond or a divalent (hetero)hydrocarbyl group.

In one embodiment, R⁸ is a divalent hydrocarbon bridging group of about 1 to 20 carbon atoms, including alkylene and arylene and combinations thereof, optionally including in the backbone 1 to 5 moieties selected from the group consisting of —O—, —C(O)—, —S—, —SO₂— and —NR¹— groups (and combinations thereof such as —C(O)—O—), wherein R¹ is hydrogen, or a C₁-C₄ alkyl group. In another embodiment, R⁸ is a poly(alkylene oxide) moiety of the formula —(OCH₂CH₂—)_{f}(OCH₂CH(R¹))_{g}—, wherein f is at least 5, g may be 0, and particularly at least about 1, and the mole ratio of f:g is at least 2:1 (particularly at least 3:1), and R¹ is H or a C₁-C₄ alkyl.

Particularly, R⁸ is a divalent alkylene,Y is a hydrolysable group, including alkoxy, acyloxy and halo; R⁹ is a monovalent alkyl or aryl group, p is 1, 2 or 3, particularly 3.

Useful silane monomers include, for example, 3-(methacryloyloxy) propyltrimethoxysilane, 3-acryloxypropyltrimethoxysilane, 3-acryloyloxypropyltriethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy) propyldiethylethoxysilane, vinyldimethylethoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, and mixtures thereof.

The optional silane monomers [M^{Sil}] are used in amounts of 0 to 10, particularly 1-5, parts by weight, relative to 100 parts by weight total monomer. Such optional silane monomers are used as adhesion promoters for improved bonding to metal, to silaceous surfaces, to surfaces having —OH groups, or as a self-crosslinking group for the curable composition.

The oligomer further comprises polymerized monomer units having a pendent ethylenically unsaturated polymerizable group. The ethylenically unsaturated group is provided to the oligomer by an indirect route whereby a portion of the pendent hydroxyl groups of the oligomer are further functionalized by reaction with a co-reactive, electrophilic compound having an ethylenically unsaturated group—“co-reactive monomers”.

The co-reactive functional group particularly comprises a carboxyl, isocyanato, epoxy, anhydride, or oxazolinyl group, oxazolinyl compounds such as 2-ethenyl-1,3-oxazolin-5-one and 2-propenyl-4,4-dimethyl-1,3-oxazolin-5-one; carboxy-substituted compounds such as (meth)acrylic acid and 4-carboxybenzyl (meth)acrylate; isocyanato-substituted compounds such as isocyanatoethyl (meth)acrylate and 4-isocyanatocyclohexyl (meth)acrylate; epoxy-substituted compounds such as glycidyl (meth)acrylate; aziridinyl-substituted compounds such as N-acryloylaziridine and 1-(2-propenyl)-aziridine; and acryloyl halides such as (meth)acryloyl chloride.

Particularly suitable co-reactive monomers have the general formula

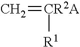

wherein R¹ is hydrogen, a C₁ to C₄ alkyl group, or a phenyl group, particularly hydrogen or a methyl group; R² is a single bond or a (hetero)hydrocarbyl divalent linking group that joins an ethylenically unsaturated group to co-reactive functional group A and contains up to 34, particularly up to 18, more particularly up to 10, carbon and, optionally, oxygen and nitrogen atoms and, when R² is not a single bond, is selected from

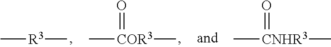

wherein R³ is an alkylene group having 1 to 6 carbon atoms, a 5- or 6-membered cycloalkylene group having 5 to 10 carbon atoms, or an alkylene-oxyalkylene in which each alkylene includes 1 to 6 carbon atoms or is a divalent aromatic group having 6 to 16 carbon atoms; and A is a co-reactive functional group capable of reacting with pendent hydroxyl group of the oligomer for the incorporation of a free-radically polymerizable functional group.

An alternate but direct method of incorporation of the pendent ethylenically unsaturated group is to include a polyethylenically unsaturated monomer (such as ethylene glycol diacrylate, propylene glycol dimethacrylate, trimethylolpropane triacrylate, or 1,6-hexamethylenedioldiacrylate) in the monomer mix. However, it has been determined that the use of such polyethylenically unsaturated monomers leads to extensive branching and/or crosslinking, and is therefore precluded in favor of the indirect method of functionalizing a portion of the pendent hydroxyl groups. Preferably, the curable composition contains no polyethylenically unsaturated monomer or other crosslinking agents.

The oligomer is prepared and then subsequently functionalized with the pendent, ethylenically unsaturated group. That is, the acrylic ester monomer, hydroxyl functional monomer and optional other polar monomer are combined and polymerized to produce the hydroxyl functional oligomer.

The oligomer may be prepared using radical polymerization techniques by combining an initiator and monomers in the presence of a chain transfer agent. In this reaction, a chain transfer agent transfers the active site on one growing chain to another molecule that can then start a new chain so the degree of polymerization may be controlled. The M_{w} of the oligomer is 4 to 30K, preferably 8 to 15 k. It has been found if the degree of polymerization is too high, the composition is too high in viscosity, and not easily processible. Conversely, if the degree of polymerization is too low, the modulus, adhesion and other mechanical properties are diminished (at a constant degree of functionalization).

Chain transfer agents may be used when polymerizing the monomers described herein to control the molecular weight of the resulting oligomer. Suitable chain transfer agents include halogenated hydrocarbons (e.g., carbon tetrabromide) and sulfur compounds (e.g., lauryl mercaptan, butyl mercaptan, ethanethiol, and 2-mercaptoethyl ether, isooctyl thioglycolate, t-dodecylmercaptan, 3-mercapto-1,2-propanediol), and ethyleneglycol bisthioglycolate. The amount of chain transfer agent that is useful depends upon the desired molecular weight of the oligomer and the type of chain transfer agent. The chain transfer agent is typically used in amounts from about 0.1 parts to about 10 parts; preferably 0.1 to about 8 parts; and more preferably from about 0.5 parts to about 4 parts based on total weight of the monomers.

The mixture further comprises an effective amount of one or more free-radical polymerization initiators. The free-radical polymerization initiators and their amount and the polymerization conditions are selected to effect a partial polymerization of the mixture providing the required conversion of monomers to polymer to a degree of between 85-99 wt. % with respect to the mass of the monomers prior to polymerization, and a viscosity of the partially polymerized mixture of between 1,000-500,000 mPas at 20° C. The term “free-radical polymerization initiators” as used above and below includes initiators which can be thermally activated or activated by actinic radiation such as, in particular, UV-radiation.

The mixture comprises one or more thermally activatable free-radical polymerization initiators. Suitable thermally activatable free-radical polymerization initiators include organic peroxides, organic hydroperoxides, and azo-group initiators which produce free-radicals. Useful organic peroxides include but are not limited to compounds such as benzoyl peroxide, di-t-amyl peroxide, t-butyl peroxy benzoate, and di-cumyl peroxide. Useful organic hydroperoxides include but are not limited to compounds such as t-amyl hydroperoxide and t-butyl hydroperoxide. Useful azo-group initiators include but are not limited to the Vazo™ (compounds manufactured by DuPont, such as Vazo™ 52 (2,2′-azobis(2,4-dimethylpentanenitrile)), Vazo™ 64 (2,2′-azobis(2-methyl-propanenitrile)), Vazo™ 67 (2,2′-azobis(2-methylbutanenitrile)), and Vazo™ 88 (2,2′-azobis(cyclohexane-carbonitrile)).

The extant oligomeric mixture described supra is combined with a photoinitiator and additional diluent monomer, then further polymerized. The diluents monomers can be used to adjust the viscosity of the composition. Up to 50, preferably up to 20, more preferably up to 10, parts by weight of diluent monomer may be added.

The diluent monomers may be the same monomers described supra, in the amounts described. In some embodiments the diluent monomer component comprises:
80 to 100 parts by weight of (meth)acrylate ester monomers;
0 to 20 parts by weight of hydroxy-functional monomers;
0 to 5 parts by weight of polar monomers;
0 to 2 parts by weight of silyl functional monomers, wherein the sum of the monomer is
100 parts by weight. In some embodiments the hydroxyl-functional monomer is used in amounts such the curable composition (oligomer +diluent) has a hydroxyl content greater than 8.3×10⁻⁴ mol OH/g.

The composition comprises less than 50 wt. % of the diluent monomers and greater than 50 wt. % of the solute oligomer, and a photoinitiator in concentrations ranging from about 0.001 to about 5.0 pbw, particularly from about 0.001 to about 1.0 pbw, and more particularly from about 0.01 to about 0.5 pbw, per 100 pbw of the monomers.

Photoinitiators are used in the liquid compositions for curing with UV-radiation. Photoinitiators for free radical curing include organic peroxides, azo compounds, quinines, nitro compounds, acyl halides, hydrazones, mercapto compounds, pyrylium compounds, imidazoles, chlorotriazines, benzoin, benzoin alkyl ethers, ketones, phenones, and the like. For example, the adhesive compositions may comprise ethyl-2,4,6-trimethylbenzoylphenylphosphinate available as LUCIRIN™ TPO-L from BASF Corp. or 1-hydroxycyclohexyl phenyl ketone available as IRGACURE™ 184 from Ciba Specialty Chemicals.

The total amount of photo initiators and, optionally, of one or more co-initiators typically is in the range of about 0.001 wt. % to about 5 wt. % and particularly in the range of about 0.1 wt. % to about 3 wt. % with respect to the mass of the curable composition.

The radiation-curable precursor (oligomer and diluent) has a Brookfield viscosity of between 1,000 to 500,000 mPas, particularly of between 2,000 and 125,000 mPas, more particularly between 2,000 to 75,000 and most particularly between 2,000 and 50,000 mPas at 20° C. If the radiation-curable composition is applied to a substrate by printing it has a Brookfield viscosity at 20° C. of between 1,000 and 30,000 mPas and more particularly between 2,000 and 25,000 mPas.

Further components and additives may be included into the curable composition such as, for example, heat stabilizers, antioxidants, antistatic agents, thickeners, fillers, pigments, dyes, colorants, thixotropic agents, processing aides, nanoparticles, fibers and any combination thereof in amounts such that the optical properties of the adhesive are not significantly compromised. Such additives are generally in an amount of between 0.01 and 10 wt. % and more preferably in an amount of between 0.05 and 5 wt. % with respect to the mass of curable composition. In some embodiment the curable composition and subsequent adhesive contain no such additives.

In some embodiments the curable composition may further comprise metal oxide particles to modify the refractive index of the adhesive layer or the viscosity of the liquid adhesive. Metal oxide particles that are substantially transparent may be used. Metal oxide particles may be used in an amount needed to produce the desired effect, for example, in an amount from about 1 to about 10 weight percent, from about 3.5 to about 7 weight percent, from about 10 to about 85 weight percent, or from about 40 to about 85 weight percent, based on the total weight of the curable composition. Metal oxide particles may only be added to the extent that they do not add undesirable color, haze or transmission characteristics. Generally, the particles can have an average particle size of from about 1 nm to about 100 nm.

The metal oxide particles can be surface treated to improve dispersibility in the adhesive layer and the composition from which the layer is coated. Examples of surface treatment chemistries include silanes, siloxanes, carboxylic acids, phosphonic acids, zirconates, titanates, and the like. Techniques for applying such surface treatment chemistries are known.

In some embodiments, the adhesive layer includes a fumed silica. Suitable fumed silicas include, but are not limited to: AEROSIL™ 200; AEROSIL™ R805; and EVONIK™ VP NKC 130 (both available from Evonik Industries); CAB-O-SIL™ TS 610; and CAB-O-SIL™ T 5720 (both available from Cabot Corp.), and HDK™ H20RH (available from Wacker Chemie AG). In some embodiments, the adhesive layer comprises a fumed aluminum oxide, such as AEROXIDE™ ALU 130 (available from Evonik, Parsippany, N.J.). In some embodiments, the adhesive layer comprises clay such as GARAMITE™ 1958 (available from Southern Clay Products).

In some embodiments, the liquid optically clear adhesive includes non-reactive oligomeric rheology modifiers. While not wishing to be bound by theory, non-reactive oligomeric rheology modifiers build viscosity at low shear rates through hydrogen bonding or other self-associating mechanisms. Examples of suitable non-reactive oligomeric rheology modifiers include, but are not limited to: polyhydroxycarboxylic acid amides (such as BYK 405, available from Byk-Chemie GmbH, Wesel, Germany), polyhydroxycarboxylic acid esters (such as BYK R-606 ™, available from Byk-Chemie GmbH, Wesel, Germany), modified ureas (such as DISPARLON 6100 ™, DISPARLON 6200 ™ or DISPARLON 6500 ™ from King Industries, Norwalk, Conn. or BYK 410 ™ from Byk-Chemie GmbH, Wesel, Germany), metal sulfonates (such as K-STAY™ 501 from King Industries, Norwalk, Conn. or IRCOGEL 903 ™ from Lubrizol Advanced Materials, Cleveland, Ohio), acrylated oligoamines (such as GENOMER 5275 ™ from Rahn USA Corp, Aurora, Ill.), polyacrylic acids (such as CARBOPOL 1620 ™ from Lubrizol Advanced Materials, Cleveland, Ohio), modified urethanes (such as K-STAY 740 ™ from King Industries, Norwalk, Conn.), micronized amide waxes (such as CRAYVALLAC SLT™ from Arkema), micronized amide modified castor oil waxes (such as CRAYVALLAC MT™ from Arkema), micronized castor oil derived waxes (such as CRAYVALLAC ANTISETTLE CVP™ from Arkema), pre-activated amide wax dispersed in (meth)acrylate monomers (such as CRAYVALLAC E00054) or polyamides. In some embodiments, non-reactive oligomeric rheology modifiers are chosen to be miscible and compatible with the optically clear adhesive to limit phase separation and minimize haze.

In some embodiments, the adhesive layer may be formed from a thixotropic liquid optically clear adhesive. As used herein, a composition is considered thixotropic if the composition shear thins, i.e., viscosity decreases when the composition is subjected to a shearing stress over a given period of time with subsequent recovery or partial recovery of viscosity when the shearing stress is decreased or removed. Such adhesives exhibit little or no flow under zero or near-zero stress conditions. The advantage of the thixotropic property is that the adhesive can be dispensed easily by such processes as needle dispensing due to the rapid decrease in viscosity under low shear rate conditions. The main advantage of thixotropic behavior over simply high viscosity is that high viscosity adhesive is difficult to dispense and to flow during application. Adhesive compositions can be made thixotropic by adding particles to the compositions. In some embodiments, fumed silica is added to impart thixotropic properties to a liquid adhesive, in an amount of from about 2 to about 10 wt. %, or from about 3.5 to about 7 wt. %.

The curable composition optionally comprises a plasticizer that increases its softness and flexibility to the resultant adhesive. Plasticizers are well known and typically do not participate in polymerization of (meth)acrylate groups. The plasticizer may comprise more than one plasticizer material. The adhesive may comprise from greater than 1 to about 20 weight percent, or from greater than 3 to about 15 weight percent, of the plasticizer. The particular plasticizer used, as well as the amount used, may depend on a variety of factors.

The curable composition may comprise a tackifier. Tackifiers are well known and are used to increase the tack or other properties of an adhesive. There are many different types of tackifiers but nearly any tackifier can be classified as: a rosin resin derived from wood rosin, gum rosin or tall oil rosin; a hydrocarbon resin made from a petroleum-based feedstock; or a terpene resin derived from terpene feedstocks of wood or certain fruits.

The adhesive layer may comprise, e.g., from 0.01 to about 20 weight percent, from 0.01 to about 15 weight percent, or from 0.01 to about 10 weight percent of tackifier. The adhesive layer may be free of tackifier.

The adhesive resulting from photopolymerization of the curable composition is desirably optically clear. As used herein, the term “optically clear” refers to a material that has a luminous transmission of greater than about 90 percent, a haze of less than about 2 percent, and opacity of less than about 1 percent in the 350 to 800 nm wavelength range. Both the luminous transmission and the haze can be determined using, for example, ASTM-D 1003-95. Typically, the optically clear adhesive may be visually free of bubbles.

The adhesive layer desirably maintains optical clarity, bond strength, and resistance to delamination over the lifetime of the article in which it is used. Whether an adhesive will likely have these desirable characteristics can be determined using an accelerated aging test. The adhesive layer can be positioned between two substrates for this test. The resulting laminate is then exposed to elevated temperatures, optionally, combined with elevated humidity conditions, for a period of time. For example, the adhesive layer can often retain its optical clarity after aging at 85° C. for approximately 500 hours without humidity control (i.e., the relative humidity in the oven is usually below about 10 percent or below about 20 percent). Alternatively, the adhesive can often retain its optical clarity after aging at 65° C. for approximately 72 hours with a relative humidity of about 90 percent. Most importantly, the cloud point resistant adhesive can often retain its optical clarity after aging at 65° C. for approximately 72 hours with a relative humidity of about 90 percent and rapid (i.e. within minutes) cooling to ambient conditions. After aging, the average transmission of the adhesive between 350 nanometers (nm) and 800 nm can be greater than about 85 percent and the haze can be less than about 2 percent. Although the adhesive composition is described as a liquid optically clear adhesive (LOCA) throughout the specification, any adhesive composition that is curable through the light absorbing layer may be used without departing from the intended scope of the present invention.

The adhesive layer resulting from photopolymerization of the curable composition desirably has a shear modulus of about 5000 to about 1,000,000, particularly about 5000 to about 100,000, more particularly about 5000 to about 100,000 pascals.

The adhesive layer can be any thickness, although as the thickness increases, the ability to cure becomes more difficult. In one embodiment, the adhesive layer has a thickness of up to about 250 μm and particularly up to about 450 μm.

Using the method of the present invention allows for an adhesive composition to be cured by UV radiation through an ink step. The method eliminates the need to pre-cure prior to lamination, perform a secondary cure or irradiate from the side of the display configuration. By curing an adhesive composition using the method of the present invention, adhesion performance is increased, display defects are decreased and costs are eliminated.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Liquid Optically Clear Adhesives Used

P-LOCA 1088 is a commercially available liquid optically clear adhesive from 3M.
LOCA COMPOSITION 1 is a developmental liquid optically clear adhesive from 3M.
LOCA COMPOSITION 2 is a developmental liquid optically clear adhesive from 3M.

### Commercially Available Materials Used

| Designator | Name | Source |
|---|---|---|
| VAZO 52 | 2,2′-azobis(2,4 dimethylpentanenitrile) | Dupont, Wilmington, DE |
| VAZO 67 | 2,2′-azobis(2-methylbutanenitrile) | Dupont, Wilmington, DE |
| VAZO 88 | 2,2′-azobis(cyclohexanecarbonitrile) | Dupont, Wilmington, DE |
| MEHQ | 4-methoxyphenol | Sigma-Aldrich, St. Louis, MO |
| 2-EHA | 2-ethylhexyl acrylate | BASF |
| TDA | Tridecyl acrylate | Sartomer |
| 2-HPA | 2-hydroxypropyl acrylate | Dow Chemical Co. |
| IOTG | Isooctyl thiolglycolate | Evans Chemetics Co. |
| IEM | Isocyanatoethyl Methacrylate | Showa Denko |
| Silane A-174 | 3-(Trimethoxysilyl)propyl methacrylate | Momentive Performance Suppliers |
| EGBTG | Ethylene glycol bisthioglycolate | Evans Chemetics Co. |
| BHT | Butylated Hydroxytoluene | Oxiris Chemicals SA |
| AO503 | Di(tridecyl) 3,3′-thiodipropionate | Evans Chemetics Co. |
| 2-EHMA | 2-ethylhexyl methacrylate | Lucite International Inc |
| 2-HPMA | 2-hydroxypropyl methacrylate | The Dow Chemical Co |
| Irgacure TPO-L | 2,4,6-trimethylbenzoylphenylphosphinate | BASF |

### Loca Composition 1-Preparation

In the first step of the polymerization, a stainless steel reaction vessel was charged with 76 parts per hundred (pph) of tridecyl acrylate (TDA), 26 pph 2-hydroxypropyl acrylate (2-HPA), 1.8 pph isooctyl thiolglycolate (IOTG), 0.02 pph MEHQ, and 0.0007 pph Vazo 52. The reactor was sealed and purged of oxygen and then held at approximately 5 psig (34.5 kPa) nitrogen pressure. The reaction mixture was heated to an induction temperature of 60° C. and the polymerization reaction proceeded adiabatically peaking at approximately 116° C. When the reaction was complete, the mixture was cooled to 60° C. The reaction mixture polymerized to 41.9% solids as determined by gravimetric analysis.

In the second step of polymerization, 0.76 pph IOTG, 0.02 pph Vazo 52, 0.01 pph Vazo 67, and 0.005 pph Vazo 88 were added to the reaction mixture. The reactor was sealed and purged of oxygen and held at 5 psig (34.5 kPa) nitrogen pressure. The reaction mixture was heated to 60° C. and the reaction proceeded adiabatically, peaking at approximately 132° C. Next, the reaction mixture was cooled to 115° C. and 0.005 pph Vazo 52 was added and the mixture was held at 115° C. for 3 hours.

Next, the mixture was cooled to 90° C. and 3 pph of isocyanatoethyl methacrylate (IEM) was added. A slow stream of a mixture of 90/10 nitrogen/oxygen by volume was bubbled through the mixture as it was held at 90° C. for 2 hours.

Next, 27.86 pph of a mixture of 18.05% by weight alkylsiloxane-treated fumed silica, 18.05% by weight TDA and 63.5% by weight heptanes was added. Silane A-174 at 0.11 pph and butylated hydroxytoluene at 0.05 pph were also added prior to draining the product.

Residual heptane was stripped from the batch and TPO-L was added to the mixture at 0.1 pph.

### Loca Composition 2 Preparation

In the first step of the polymerization, a stainless steel reaction vessel was charged with 33 parts per hundred (pph) of 2-ethylhexyl acrylate (2-EHA), 17 pph of 2-hydroxypropyl methacrylate (2-HPMA), 43 pph of 2-ethylhexyl methacrylate (2-EHMA), 7 pph of 2-hydroxypropyl acrylate (2-HPA), and 4.4 pph of ethylene glycol bisthioglycolate (EGBTG). The reactor was sealed and purged of oxygen and then held at approximately 5 psig (34.5 kPa) nitrogen pressure. The reaction mixture was heated to an induction temperature of 60° C. and the polymerization reaction proceeded adiabatically, peaking at approximately 119° C. When the reaction was complete, the mixture was cooled to 60° C.

In the second step of polymerization, 1.47 pph EGBTG, 0.02 pph Vazo 52, 0.04 pph Vazo 67, and 0.05 pph Vazo 88 was added to the reaction mixture. The reactor was sealed and purged of oxygen and held at 5 psig (34.5 kPa) nitrogen pressure. The reaction mixture was heated to 60° C. and the reaction proceeded adiabatically, peaking at approximately 115° C. The reaction mixture was then held at 115° C. for 3 hours.

Next, the mixture was cooled to 70° C. and 3.44 pph of isocyanatoethyl methacrylate (IEM) was added. A slow stream of a mixture of 90/10 nitrogen/oxygen by volume was bubbled through the mixture as it was held at 70° C. for 8 hours.

Next, the mixture was cooled to 60° C. and Silane A-174 at 0.136 pph, butylated hydroxytoluene at 0.05 pph, A0503 at 1.196 pph , TPO-L at 0.379 pph, and 8.907 pph of 2-hydroxy propyl methacrylate (2-HPMA) were added prior to draining the product.

### Ink Cover Lens Dosage Penetration Sample Preparation

A masking tool 200 was created to model the effect of a black ink step. Black masking tape 202 was applied to a sheet of glass 204. This design is shown in FIG. 2. Half of a major surface of the glass 204 was covered with black masking tape 202. On the other half, black masking tape 202 was applied to form a 5 mm wide border 206, leaving an open area of glass 208 exposed.

As illustrated in FIG. 3, a handspread of liquid optically clear adhesive 300 (300 μm thick) was spread between two release liners 302 (each 50 μm thick). The masking tool 200 was placed directly in contact above one of the release liners 302 and the location of the exposed area of glass 208 and measurement references were noted on the release liner.

The construction as illustrated in FIG. 3 was then irradiated using an Opas R90 conveyor machine (Opas UV, Taichung City, Taiwan) set at a dosage of 500 mJ/cm² per pass. A total dosage of either 3000 mJ/cm² or 6000 mJ/cm² was applied to the construction.

Upon cure, the masking tool 200 was removed and the areas in FIG. 4 were checked for appearance and conversion via FT-IR. In FIG. 4, area 1 is labeled 400, area 2 is labeled 402, area 3 is labeled 404, and area 4 is labeled 406.

### Ink Cover Lens Dosage Penetration Sample Results

Table 1 presents the qualitative appearance of cure after liner removal and Table 2 presents FT-IR quantification (normalized peak area at 1640 cm⁻¹) of conversion of the acrylate double bonds. As a comparison, area 2 (402 in FIG. 4) was cured 0.5 mm from the edge of the mask, but otherwise uncured for P-LOCA 1088.

TABLE 1
Appearance of cure after exposure to 3000 mJ/cm² or 6000 mJ/cm² dose,
300 μm thick film

| Area | | | | |
|---|---|---|---|---|
| (as shown | P-LOCA 2820 | | LOCA COMPOSITION 2 | |
| in FIG. 4) | 3000 mJ/cm² | 6000 mJ/cm² | 3000 mJ/cm² | 6000 mJ/cm² |
| 1 (5 mm) | Solid Film | Solid Film | Solid Film | Solid Film |
| 2 (5 mm) | Solid Film | Solid Film | Solid Film | Solid Film |
| | with little | with little | | |
| | wetness | wetness | | |
| 3 (10 mm) | Solid Film | Solid Film | Solid Film | Solid Film |
| | with some | with some | with some | with some |
| | wetness | wetness | wetness | wetness |
| 4 (15 mm) | Wet Film | Wet Film | Wet Film | Wet Film |

TABLE 2
FT-IR quantification of cure

| Area | | |
|---|---|---|
| (as shown | LOCA COMPOSITION 2 | |
| in FIG. 4) | 3000 mJ/cm² | 6000 mJ/cm² |
| 1 (5 mm) | 96.6% | 99.4% |
| 2 (5 mm) | 95.4% | 99.4% |
| 3 (10 mm) | 84.5% | 97.8% |
| 4 (15 mm) | 2.6% | 14.2% |

Table 3 presents the qualitative appearance of cure after liner removal of LOCA COMPOSITION 2 and P-LOCA 1088 at various thicknesses.

TABLE 3
Appearance of cure after exposure to 3000 mJ/cm²

| Area | LOCA | | | |
|---|---|---|---|---|
| (as shown | COMPOSITION 2 | P-LOCA 1088 | | |
| in FIG. 4) | 450 μm | 100 μm | 200 μm | 450 μm |
| 1 (5 mm) | Solid Film with | Solid Film | Solid Film | Solid Film |
| | little wetness | with little | with little | with little |
| | | wetness | wetness | wetness |
| 2 (5 mm) | Solid Film with | Almost wet | Almost wet | Almost wet |
| | little wetness | film | film | film |
| 3 (10 mm) | Almost wet film | Almost wet | Almost wet | Almost wet |
| | | film | film | film |
| 4 (15 mm) | Almost wet film | Almost wet | Almost wet | Almost wet |
| | | film | film | film |

### Photorheometry Experiment

A DHR-2 rheometer equipped with a UV-LED curing accessory (TA Instruments, Newcastle, Del.) was used for the photorheometry experiments. The bottom plate was a 20 mm flat quartz plate, enabling the transmission of 365 nm UV LED exposure from the bottom. The top plate was a 20 mm flat stainless steel plate. About 0.5 g of adhesive was dispensed from a 30 cc syringe onto the quartz plate. The gap between the two plates was then lowered to 150 μm, and excess adhesive was removed from the edges. A UV shield was put in place before running the experiment.

The experiment included a 30 second baseline before exposure, a UV dose pulse and a 150 second data collection after exposure. The experiment was run at 2% strain and a 25 Hz oscillation. The normal force was set to zero. The UV LED dosage was 50 mW/cm². Total cures of 100 mJ/cm², 200 mJ/cm², 400 mJ/cm² and 800 mJ/cm² were applied.

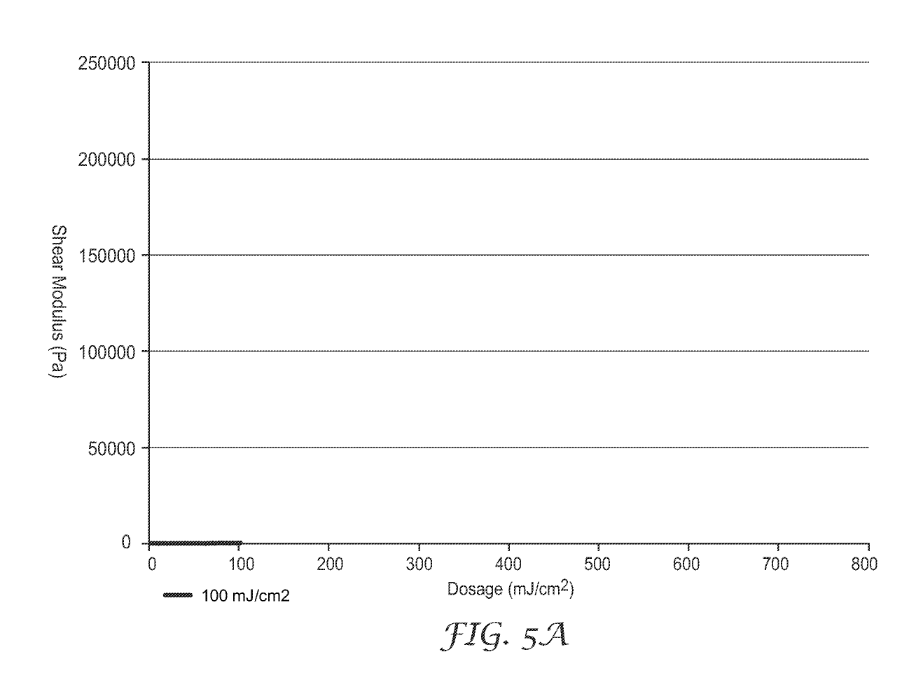

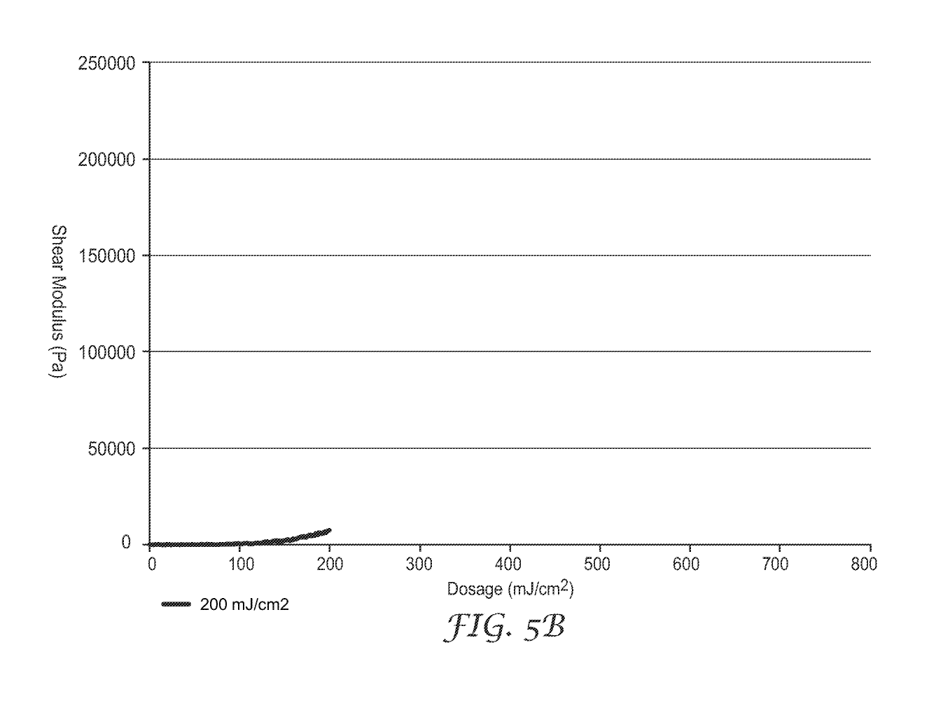

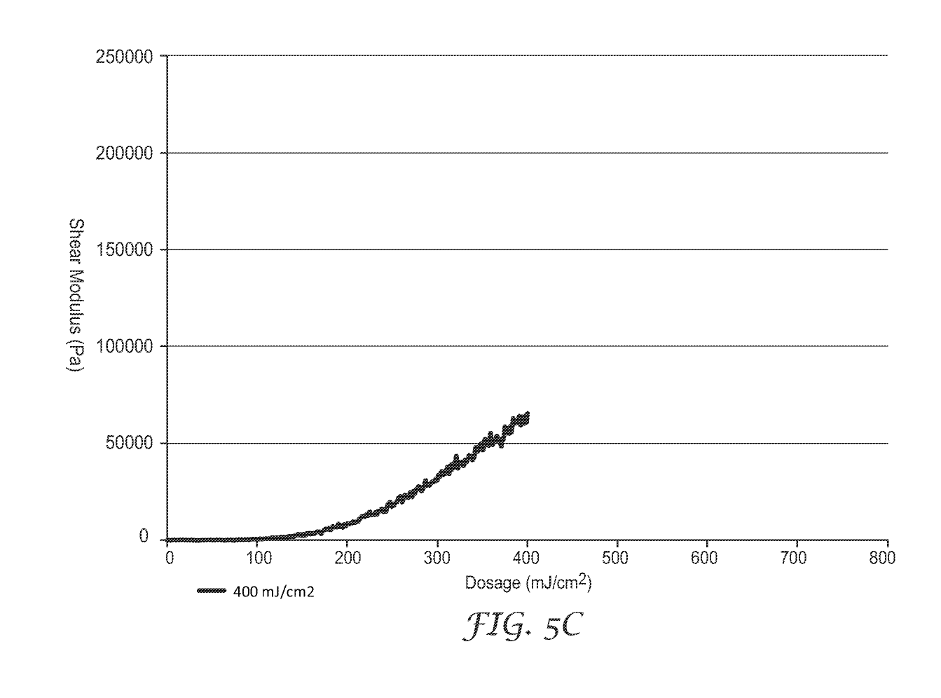

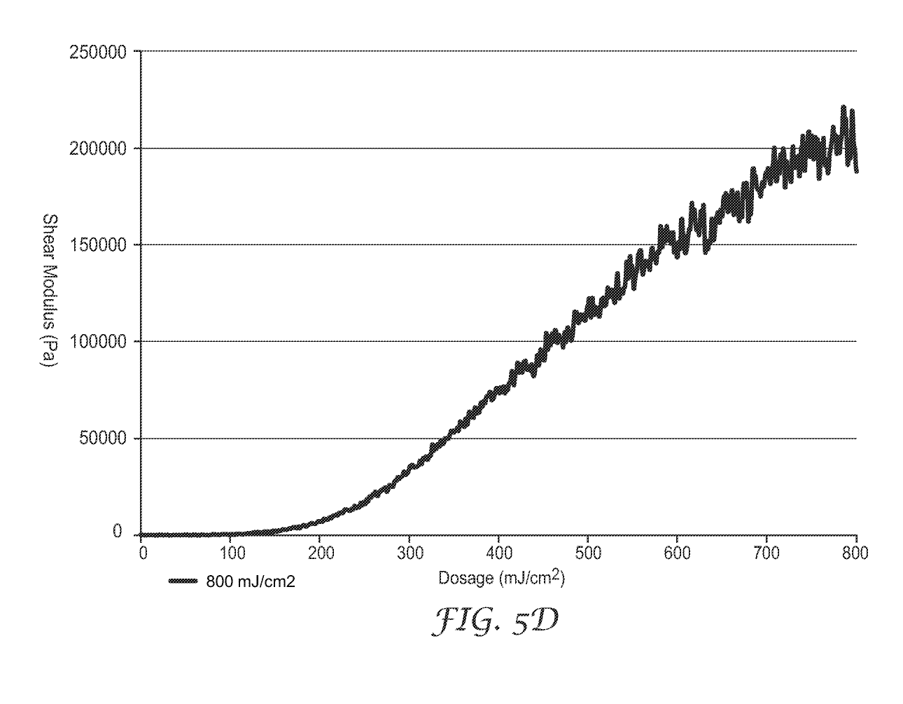

FIGS. 5a, 5b, 5c and 5d show the build of modulus as a function of dose during the curing step for cures of 100 mJ/cm², 200 mJ/cm², 400 mJ/cm² and 800 mJ/cm², respectively.

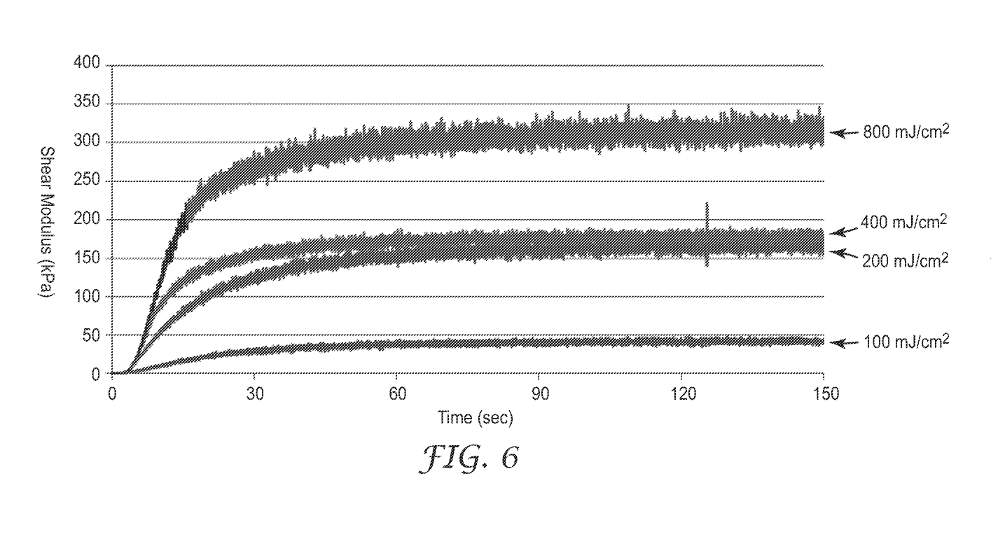

After the dosage was applied, the modulus measurement continued for 150 seconds. FIG. 6 is a graph of the modulus after the doses of FIG. 5 are applied. As can be seen in FIG. 6, the modulus continued to build after cure in the dark.

Although the present invention has been described with reference to preferred embodiments, workers skilled in the art will recognize that changes may be made in form and detail without departing from the spirit and scope of the invention.

What is claimed is:

1. A method of curing an adhesive composition positioned at least partially under a light-absorbing layer, the method comprising:
providing an adhesive composition comprising:
a solute (meth)acryolyl oligomer having a molecular weight of 4 to 30 k and a T_{g} of less than about 20° C.;
a diluents monomer component; and
a photoinitiator; and
positioning the light-absorbing layer over a surface of the adhesive composition such that there is an exposed area of the adhesive composition and a covered area of the adhesive composition; and
irradiating the exposed area of the adhesive composition and the covered area of the adhesive composition at the surface at a dosage of between about 100 mJ/cm² and about 10,000 mJ/cm².

2. The method of claim 1, wherein the solute (meth)acryolyl oligomer comprises:
greater than about 50 parts by weight of (meth)acrylate ester monomer units;
about 10 to about 49 parts by weight of monomer units having a pendent hydroxy functional group;and
about 1 to about 10 parts by weight of monomer units having a pendent, free-radically polymerizable functional groups,
wherein the sum of the monomer units is 100 parts by weight.

3. The method of claim 2, wherein the solute (meth)acryolyl oligomer further comprises up to about 20 parts by weight of other polar monomer units, wherein the sum of the monomer units is 100 parts by weight.

4. The method of claim 2, wherein the solute (meth)acryolyl oligomer further comprises up to about 10 parts by weight of silane-functional monomer units, wherein the sum of the monomer units is 100 parts by weight

5. The method of claim 1, wherein the light-absorbing layer is up to about 10 μm thick.

6. The method of claim 3, wherein the light-absorbing layer is up to about 100 μm thick.

7. The method of claim 1, wherein the dosage is between about 300 mJ/cm² and about 6,000 mJ/cm².

8. The method of claim 1, wherein the adhesive composition is up to about 250 μm thick.

9. The method of claim 8, wherein the adhesive composition is up to about 450 μm thick.

10. The method of claim 1, wherein the adhesive composition is at least about 80% cured.

11. A method of curing an adhesive composition positioned at least partially under a light-absorbing layer, the method comprising:
providing an adhesive composition;
positioning the light-absorbing layer over a surface of the adhesive composition such that there is an exposed area of the adhesive composition and a covered area of the adhesive composition; and
irradiating the surface of the adhesive composition such that the adhesive composition is at least about 80% cured.

12. The method of claim 11, wherein the adhesive composition comprises:
a solute (meth)acryolyl oligomer having a molecular weight of 4 to 30 k and a T_{g} of less than about 20° C.;
a diluents monomer component; and
a photoinitiator.

13. The method of claim 12, wherein the solute (meth)acryolyl oligomer comprises:
greater than about 50 parts by weight of (meth)acrylate ester monomer units;
about 10 to about 49 parts by weight of monomer units having a pendent hydroxy functional group; and
about 1 to about 10 parts by weight of monomer units having a pendent, free-radically polymerizable functional groups,
wherein the sum of the monomer units is 100 parts by weight.

14. The method of claim 13, wherein the solute (meth)acryolyl oligomer further comprises up to about 20 parts by weight of other polar monomer units, wherein the sum of the monomer units is 100 parts by weight.

15. The method of claim 13, wherein the solute (meth)acryolyl oligomer further comprises up to about 10 parts by weight of silane-functional monomer units, wherein the sum of the monomer units is 100 parts by weight.

16. The method of claim 11, wherein the light-absorbing layer is up to about 10 μm thick.

17. The method of claim 11, wherein the dosage is between about 100 mJ/cm² and about 10,000 mJ/cm².

18. The method of claim 11, wherein the adhesive composition is up to about 250 μm thick.

19. The method of claim 11, wherein the adhesive composition is at least about 90% cured.

20. The method of claim 11, wherein the adhesive composition is at least about 95% cured.
